(19) United States
(12) Patent Application Publication
(10) Pub. No.: US 2011/0312241 A1
(43) Pub. Date: Dec. 22, 2011

(54) Water-Soluble Multi-Layer Materials, Articles Made Therefrom, and Methods of Making and Using the Same

(76) Inventors: Ming Tang, Lawrenceville, GA (US); Haisu Fang, Zhejiang (CN); John Steward, Sedona, AZ (US)

(21) Appl. No.: 13/129,251

(22) PCT Filed: Nov. 17, 2009
(86) PCT No.: PCT/US09/64678

§ 371 Date: Jun. 9, 2011

Related U.S. Application Data
(60) Provisional application No. 61/115,243, filed on Nov. 17, 2008.

(51) Int. Cl. B32B 5/26; B32B 27/12; B32B 37/06; A41D 13/00; A41D 13/02

(52) U.S. Cl. 442/381; 2/69; 2/79; 156/272.2; 442/396

(57) ABSTRACT

Water-soluble, multi-layer materials and articles made from the materials are disclosed. Methods of making and using water-soluble, multi-layer materials and articles are also disclosed.

This application is being filed as a PCT International Patent Application in the names of (i) Eastern Technologies, Inc., a U.S. corporation, and (ii) Global Resources International, Inc., a U.S. corporation, claiming priority to U.S. Provisional Patent Application Ser. No. 61/115,243 entitled “WATER-SOLUBLE, MULTI-LAYER MATERIALS, ARTICLES MADE THEREFROM, AND METHODS OF MAKING AND USING THE SAME” and filed on 17 Nov. 2008.

### FIELD OF THE INVENTION

The present invention relates generally to water-soluble, multi-layer materials and articles made therefrom. The present invention further relates generally to methods of making water-soluble, multi-layer materials and articles made therefrom, as well as methods of using water-soluble, multi-layer materials and articles.

### BACKGROUND OF THE INVENTION

Barrier-providing materials are used in a variety of applications. For example, protective clothing for various industries, operating room gowns, and operating room drapes have been known to be made from various barrier-providing materials including, but not limited to, TYVEK® nonwoven polypropylene materials commercially available from DuPont (Wilmington, Del.). However, known barrier-providing materials have a number of shortcomings. For example, known barrier-providing materials suffer from one or more of the following shortcomings: (1) the materials are not water-soluble, which limits disposal options; (2) the materials have a limited water vapor transmission rate (WVTR) as measured using test method ASTM E96 procedure B (2005), typically less than about 1000 g/24 hr/m²; and/or (3) the materials have a WVTR of greater than about 1000 g/24 hr/m² as measured using test method ASTM E96 procedure B (2005), but do not provide enough barrier protection properties against particulate materials such as particulate radioactive materials.

What is needed in the art is a breathable barrier-providing material that (1) is water-soluble, desirably, completely water-soluble, (2) has a WVTR of greater than about 1000 g/24 hr/m² as measured using test method ASTM E96 PROCEDURE B (2005), and (3) provides superior barrier protection properties against particulate materials such as particulate radioactive materials.

### SUMMARY OF THE INVENTION

The present invention is directed to a water-soluble, breathable material and articles of manufacture made therefrom. The water-soluble, breathable material of the present invention provides one or more of the following features: (i) the ability to be disposed of via solubilizing in hot water, (ii) the ability to provide superior breathability by possessing a water vapor transmission rate (WVTR) of greater than about 2000 g/24 hr/m² as measured using test method ASTM E96 procedure B (2005), and (iii) the ability to provide superior barrier protection against particulate material such as particulate radioactive materials.

According to one exemplary embodiment of the present invention, the water-soluble, breathable material comprises a first layer of water-soluble nonwoven fabric extending along a first surface of the material, the first layer of water-soluble nonwoven fabric comprising water-soluble polyvinyl alcohol fibers, and a water-soluble polyvinyl alcohol film layer bonded to the first layer of water-soluble nonwoven fabric, the water-soluble polyvinyl alcohol film layer being substantially free of any particulate material, wherein the material has a water vapor transmission rate (WVTR) of at least about 2000 g/24 hr/m² as measured using test method ASTM E96 PROCEDURE B (2005).

The present invention is further directed to articles of clothing comprising a water-soluble, breathable material. In one exemplary embodiment, the article of clothing comprises a first layer of water-soluble nonwoven fabric extending along and forming a first exposed major surface of the article, the first layer of water-soluble nonwoven fabric comprising water-soluble polyvinyl alcohol fibers, and a water-soluble polyvinyl alcohol film layer bonded to the first layer of water-soluble nonwoven fabric and forming a second exposed major surface of the article opposite the first exposed major surface, the water-soluble polyvinyl alcohol film layer being substantially free of any particulate material, wherein the article has a water vapor transmission rate (WVTR) of at least about 2000 g/24 hr/m² as measured using test method ASTM E96 PROCEDURE B (2005).

The present invention is further directed to methods of making a water-soluble, breathable material. In one exemplary embodiment, the method of making a water-soluble, breathable material comprises feeding (i) a first layer of water-soluble nonwoven fabric comprising water-soluble polyvinyl alcohol fibers (ii) and a water-soluble polyvinyl alcohol film layer into a high frequency welding apparatus, the high frequency welding apparatus comprising a pair of nip rollers comprising (i) a first roller having a plurality of protrusions along an outer surface of the first roller, and (ii) a second roller having a substantially smooth surface, the high frequency welding apparatus providing high frequency energy across a nip area between the protrusions of the first roller and the substantially smooth surface of the second roller, and bonding the first layer of water-soluble nonwoven fabric to the water-soluble polyvinyl alcohol film layer via the high frequency energy, wherein the resulting material has a water vapor transmission rate (WVTR) of at least about 2000 g/24 hr/m² as measured using test method ASTM E96 PROCEDURE B (2005).

The present invention is even further directed to methods of using a water-soluble, breathable material. In one exemplary embodiment of the present invention, the method comprises the steps of forming an article of manufacture from a water-soluble, breathable material comprising a first layer of water-soluble nonwoven fabric extending along and forming a first exposed major surface of the article, the first layer of water-soluble nonwoven fabric comprising water-soluble polyvinyl alcohol fibers, and a water-soluble polyvinyl alcohol film layer bonded to the first layer of water-soluble nonwoven fabric and forming a second exposed major surface of the article opposite the first exposed major surface, the water-soluble polyvinyl alcohol film layer being substantially free of any particulate material, wherein the article has a water vapor transmission rate (WVTR) of at least about 2000 g/24 hr/m² as measured using test method ASTM E96 PROCEDURE B (2005). Exemplary articles of manufacture include, but are not limited to, articles of clothing such as coveralls and scrubs, as well as operating room sheets and gowns.

These and other features and advantages of the present invention will become apparent after a review of the following detailed description of the disclosed embodiments and the appended claims.

### BRIEF DESCRIPTION OF THE FIGURES

The present invention is further described with reference to the appended figures, wherein:

FIG. 1 depicts a cross-sectional view of an exemplary water-soluble, breathable material of the present invention;

FIG. 2 depicts a cross-sectional view of another exemplary water-soluble, breathable material of the present invention;

FIG. 3 depicts an exploded view of a cross-sectional section of the exemplary water-soluble, breathable material shown in FIG. 1;

FIGS. 4A-4B depict a view of an exemplary article of manufacture comprising the exemplary water-soluble, breathable material shown in FIG. 1 or FIG. 2;

FIG. 5 depicts an exemplary process flow for forming the exemplary water-soluble, breathable material shown in FIG. 1; and

FIGS. 6A-6B depict top and side views respectively of an exemplary water-soluble, breathable material of the present invention formed via the exemplary process shown in FIG. 5.

### DETAILED DESCRIPTION OF THE INVENTION

The present invention is directed to water-soluble, breathable material and water-soluble articles of manufacture made therefrom. The present invention is further directed to methods of making and using water-soluble, breathable material, as well as methods of making and using articles of manufacture comprising the water-soluble, breathable material. The water-soluble, breathable material of the present invention is particularly useful for making articles of clothing (e.g., coveralls, scrubs, pants, shirts, gloves, glove liners, etc.), as well as articles used in an operating room setting (e.g., drapes, gowns, etc.). The water-soluble, breathable material of the present invention may comprise two or more distinct layers of material, each of which provides a desired property to the resulting water-soluble, breathable material.

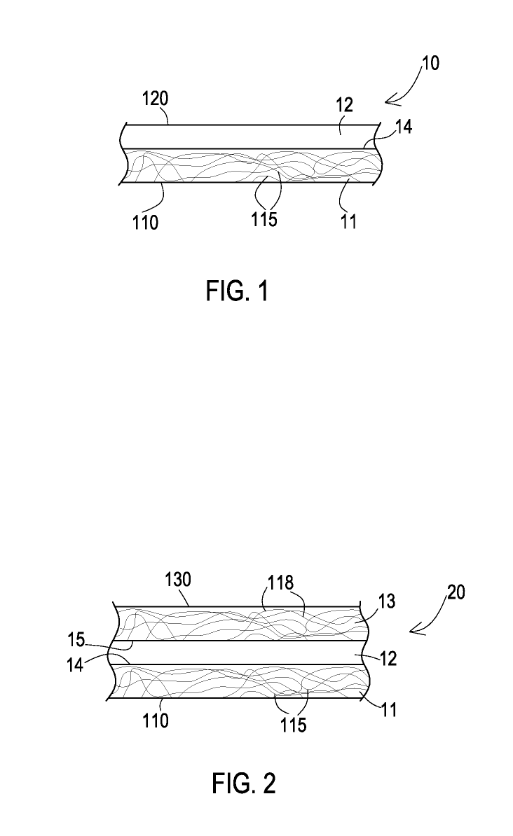

An exemplary water-soluble, breathable material 10 of the present invention is shown in FIG. 1. Exemplary water-soluble, breathable material 10 comprises a first layer of water-soluble nonwoven fabric 11 comprising water-soluble polyvinyl alcohol fibers 115 bonded to a water-soluble polyvinyl alcohol film layer 12 along bond surface 14. As discussed further below, water-soluble polyvinyl alcohol film layer 12 is free of any particulate material. In other words, water-soluble polyvinyl alcohol film layer 12 comprises only (i.e., consists essentially of or consists of) polyvinyl alcohol film material.

In exemplary water-soluble, breathable material 10, first layer of water-soluble nonwoven fabric 11 forms a first exposed major surface 110, while water-soluble polyvinyl alcohol film layer 12 forms a second exposed major surface 120.

Another exemplary water-soluble, breathable material 20 of the present invention is shown in FIG. 2. Exemplary water-soluble, breathable material 20 comprises a first layer of water-soluble nonwoven fabric 11 comprising water-soluble polyvinyl alcohol fibers 115 bonded to a water-soluble polyvinyl alcohol film layer 12 along bond surface 14. Exemplary water-soluble, breathable material 20 further comprises a second layer of water-soluble nonwoven fabric 13 comprising water-soluble polyvinyl alcohol fibers 118 bonded to a water-soluble polyvinyl alcohol film layer 12 along bond surface 15. Again, water-soluble polyvinyl alcohol film layer 12 is free of any particulate material (i.e., consists essentially of or consists of polyvinyl alcohol film material without other added materials such as particulate materials).

In exemplary water-soluble, breathable material 20, first layer of water-soluble nonwoven fabric 11 forms a first exposed major surface 110, while second layer of water-soluble nonwoven fabric 13 forms a second exposed major surface 130.

As described above, water-soluble, breathable materials of the present invention may comprise two or more distinct layers of fabric or film material. A detailed description of suitable exemplary fabric or film materials is provided below.

### I. Water-Soluble, Breathable Materials

The water-soluble, breathable materials of the present invention may comprise, but are not limited to, one or more of the following components.

A. Water-Soluble, Breathable Material Components

The water-soluble, breathable materials of the present invention may comprise one or more of the following components.

1. First Layer of Water-Soluble Nonwoven Fabric

The water-soluble, breathable materials of the present invention comprise a first layer of nonwoven fabric such as exemplary first layer of water-soluble nonwoven fabric 11 comprising water-soluble polyvinyl alcohol fibers 115 shown in FIG. 1. The first layer of nonwoven fabric layer is a liquid pervious layer that enable fluids (e.g., perspiration) coming into contact with an outer surface thereof (e.g., first exposed major surface 110) to enter into the fabric and away from the outer surface into an interior of the fabric layer (e.g., the first layer of nonwoven fabric has liquid wicking properties).

The first nonwoven fabric layer of water-soluble polyvinyl alcohol fibers may comprise one or more sub-layers of nonwoven fabric material positioned adjacent to and/or bonded to one another. In one exemplary embodiment, the first nonwoven fabric layer comprises a cross-lapped, spun-laced nonwoven fabric comprising water-soluble polyvinyl alcohol fibers.

Suitable PVA fibers and methods of making PVA fibers are disclosed in U.S. Pat. Nos. 5,181,967; 5,207,837; 5,268,222; 5,620,786; 5,885,907; and 5,891,812; the disclosures of all of which are incorporated herein by reference in their entirety. An example of a suitable water-soluble polyvinyl alcohol fiber for use in the present invention is a polyvinyl alcohol homopolymer that has been highly crystallized by post-drawing or by heat annealing. Any commercially available polyvinyl alcohol fiber is suitable for use in the present invention including, but not limited to, polyvinyl alcohol fibers commercially available from SINOPEC SINCHUAN VINYLON WORKS Company (Sichuan, China); Fujian Textile and Chemical Fiber Group Co. Ltd. (Fujian, China); and Hunan Xiangwei Co. Ltd. (Hunan, China).

Polyvinyl alcohol fibers are particularly preferred due to their absorbency characteristics and hot water solubility. It is preferred that the temperature of water solubility of first layer of nonwoven fabric 11 be considerably above body temperature so that it is absorbent for normal bodily fluids, but still water-soluble at elevated temperatures for environmental reasons. It is preferred that first layer of nonwoven fabric 11 is soluble in water having a water temperature of greater than about 37° C. It is more preferred that first layer of nonwoven fabric 11 is soluble in water having a water temperature of greater than about 50° C. It is even more preferred that first layer of nonwoven fabric 11 is soluble in water having a water temperature of greater than about 75° C. It is even more preferred that first layer of nonwoven fabric 11 is soluble in water having a water temperature of greater than about 90° C.

The polyvinyl alcohol fibers of the first nonwoven fabric layer desirably have an average fiber diameter of less than about 100 microns. More desirably, the polyvinyl alcohol fibers of the first nonwoven fabric layer have an average fiber diameter of from about 0.5 micron to about 40 microns. Even more desirably, the polyvinyl alcohol fibers have an average fiber diameter of from about 1.0 micron to about 30 microns.

The first nonwoven fabric layer desirably has an overall basis weight (i.e., a basis weight of the one or more nonwoven fabric sub-layers combined) of less than about 60 grams per square meter (gsm). More desirably, the first nonwoven fabric layer has an overall basis weight of from about 25 gsm to about 55 gsm. Even more desirably, the first nonwoven fabric layer has an overall basis weight of about 45 gsm.

The first nonwoven fabric layer may have an overall thickness (i.e., a thickness of the one or more nonwoven fabric sub-layers combined), which varies depending upon the particular end use of the article. Desirably, the first nonwoven fabric layer has an overall thickness of less than about 1000 microns (μm). More desirably, the first nonwoven fabric layer has an overall thickness of from about 10 μm to about 500 μm. Even more desirably, the first nonwoven fabric layer has an overall thickness of from about 20 μm to about 100 μm.

In one exemplary embodiment, the first nonwoven fabric layer comprises a cross-lapped, spunlaced fabric of polyvinyl alcohol fibers, wherein the spunlaced fabric has a basis weight of about 45 gsm.

2. Water-Soluble Polyvinyl Alcohol Film Layer

The water-soluble, breathable materials of the present invention further comprise a water-soluble polyvinyl alcohol film layer such as exemplary water-soluble polyvinyl alcohol film layer 12 of exemplary water-soluble, breathable material 10 shown in FIG. 1. The water-soluble polyvinyl alcohol film layer may comprise one or more sub-layers of polyvinyl alcohol material positioned adjacent to and/or bonded to one another.

The water-soluble polyvinyl alcohol film layer (e.g., exemplary water-soluble polyvinyl alcohol film layer 12) comprises polyvinyl alcohol that is free of particulate material. In some embodiments, the water-soluble polyvinyl alcohol film layer consists essentially of polyvinyl alcohol film material. In other embodiments, the water-soluble polyvinyl alcohol film layer consists of polyvinyl alcohol film material.

The water-soluble polyvinyl alcohol film layer (e.g., exemplary water-soluble polyvinyl alcohol film layer 12) is liquid impervious, but pervious to vapor (e.g., water vapor) (i.e., breathable) so that gases and vapor may pass through the layer but liquids and particulate material does not. Commercially available polyvinyl alcohol film material suitable for use in the present invention includes, but is not limited to, polyvinyl alcohol film material commercially available from Kuraray Co., Ltd. (Japan).

The water-soluble polyvinyl alcohol film layer (e.g., exemplary water-soluble polyvinyl alcohol film layer 12) (and the entire article, such as exemplary water-soluble, breathable material 10) is desirably water-soluble in water having a water temperature of greater than about 37° C. (or greater than about 50° C., or greater than about 75° C., or greater than about 90° C.).

The water-soluble polyvinyl alcohol film layer may have an overall thickness (i.e., a thickness of the one or more polyvinyl alcohol film sub-layers combined), which varies depending upon the particular end use of the article. Desirably, the water-soluble polyvinyl alcohol film layer has an overall thickness of less than about 100 microns (μm). More desirably, the water-soluble polyvinyl alcohol film layer has an overall thickness of from about 10 μm to about 64 μm. Even more desirably, the water-soluble polyvinyl alcohol film layer has an overall thickness of from about 10 μm to about 25 μm. In one exemplary embodiment, the water-soluble polyvinyl alcohol film layer has an overall thickness of about 15 μm.

The water-soluble polyvinyl alcohol film layer desirably has an overall basis weight (i.e., a basis weight of the one or more polyvinyl alcohol film sub-layers combined) of less than about 45 grams per square meter (gsm). More desirably, the polyvinyl alcohol film layer has an overall basis weight of from about 5 gsm to about 45 gsm. Even more desirably, the polyvinyl alcohol film layer has an overall basis weight of about 20 gsm to about 35 gsm.

At least a portion of the water-soluble polyvinyl alcohol film layer is bonded to at least a portion of the above-described first layer of nonwoven fabric. In one exemplary embodiment, such as exemplary water-soluble, breathable material 10 shown in FIG. 1, the water-soluble polyvinyl alcohol film layer is bonded to the first layer of nonwoven fabric in a uniform manner (e.g., point-bonded) along bond surface 14. In other embodiments, water-soluble polyvinyl alcohol film layer may be bonded to the first layer of nonwoven fabric in desired areas, which may or may not be uniformly distributed along bond surface 14.

The breathable unstretched water-soluble polyvinyl alcohol film used to form exemplary water-soluble, breathable material 10 typically has a water vapor transmission rate (WVTR) of at least 1000 g/24 hr/m² as measured using test method ASTM E96 PROCEDURE B (2005), but less than about 2000 g/24 hr/m² as measured using test method ASTM E96 PROCEDURE B (2005).

The water-soluble polyvinyl alcohol film layer may comprise a polyvinyl alcohol matrix with one or more optional additives (e.g., pigments, antimicrobial agents, etc.) distributed throughout the polyvinyl alcohol matrix. In one exemplary embodiment, the polyvinyl alcohol film layer comprises a polyvinyl alcohol matrix comprising from about 95 wt % to 100 wt % of polyvinyl alcohol, and from about 5 wt % to 0 wt % of one or more additives (e.g., pigments, antimicrobial agents, etc.). Typically, the polyvinyl alcohol film layer comprises a polyvinyl alcohol matrix comprising 100 wt % of polyvinyl alcohol, and 0 wt % of one or more additives.

In one desired embodiment, the polyvinyl alcohol film layer comprises an optically clear polyvinyl alcohol film commercially available from Kuraray Co., Ltd. (Japan).

3. Second Layer of Water-Soluble Nonwoven Fabric

The water-soluble, breathable material of the present invention may further comprise a second layer of water-soluble, nonwoven fabric such as exemplary second layer of water-soluble nonwoven fabric 13 of exemplary water-soluble breathable material 20 shown in FIG. 2. The second layer of water-soluble, nonwoven fabric is preferably a liquid pervious layer so as to enable fluids coming into contact with an outer surface of the article to enter into the fabric layer and away from the outer surface of the fabric layer (e.g., the second layer of nonwoven fabric has liquid wicking properties).

The second layer of water-soluble, nonwoven fabric of the water-soluble, breathable material, when present, is typically similar to if not identical to the above-described first layer of water-soluble, nonwoven fabric. In one exemplary embodiment, the second layer of water-soluble, nonwoven fabric is essentially identical to the first layer of water-soluble, nonwoven fabric. In other embodiments, first and second water-soluble, nonwoven fabric layers differ from one another so as to impart a combination of properties to the resulting water-soluble, breathable material 20. For example, in one exemplary embodiment, second layer of water-soluble, nonwoven fabric 13 is treated with a water repellant treatment, while first layer of water-soluble, nonwoven fabric 11 is untreated. The resulting water-soluble, breathable material has a second major outer surface 130 that is water repellent (i.e., hydrophobic) and a first major outer surface 110 that is water absorbent (i.e., hydrophilic).

Like the first water-soluble, nonwoven fabric layer, the second water-soluble, nonwoven fabric layer may comprise one or more sub-layers of water-soluble, nonwoven fabric material positioned adjacent to and/or bonded to one another. In one exemplary embodiment, the second water-soluble, nonwoven fabric layer comprises a cross-lapped, spun-laced water-soluble fabric comprising water-soluble polyvinyl alcohol fibers.

As with the first water-soluble, nonwoven fabric layer, second water-soluble, nonwoven fabric layer 13 is desirably water-soluble in water having a water temperature of greater than about 37° C. (or greater than about 50° C., or greater than about 75° C., or greater than about 90° C.).

The second water-soluble, nonwoven fabric layer, when present, desirably has an overall basis weight (i.e., a basis weight of the one or more nonwoven fabric sub-layers combined) of less than about 60 grams per square meter (gsm). More desirably, the second water-soluble, nonwoven fabric layer has an overall basis weight of from about 25 gsm to about 55 gsm. Even more desirably, the second water-soluble, nonwoven fabric layer has an overall basis weight of about 45 gsm.

The second water-soluble, nonwoven fabric layer may have an overall thickness (i.e., a thickness of the one or more nonwoven fabric sub-layers combined), which varies depending upon the particular end use of the article. Desirably, the second water-soluble, nonwoven fabric layer has an overall thickness of less than about 1000 microns (μm). More desirably, the second water-soluble, nonwoven fabric layer has an overall thickness of from about 10 μm to about 500 μm. Even more desirably, the second water-soluble, nonwoven fabric layer has an overall thickness of from about 20 μm to about 100 μm.

In one exemplary embodiment, the second water-soluble, nonwoven fabric layer comprises a cross-lapped, spunlaced fabric of polyvinyl alcohol fibers, wherein the spunlaced fabric has a basis weight of about 45 gsm.

4. Additives

Any of the above-described water-soluble layers may further comprise one or more additives coated onto or incorporated into one or more of the materials used to form an individual layer. Suitable additives include, but are not limited to, antimicrobial agents, colorants (e.g., pigments), softeners, additives to increase or decrease the coefficient of friction of a given component layer, additives to increase the hydrophilicity of a given component layer, flame retardants, etc. In one desired embodiment of the present invention, one or more components of the above-described water-soluble layers comprise an antimicrobial agent incorporated therein. Suitable antimicrobial agents include, but are not limited to, triclosan and other antimicrobial agents commercially available under the trade designation MICROBAN® from Microban International, Ltd. (New York, N.Y.).

In one exemplary embodiment, first layer of water-soluble nonwoven fabric 11, water-soluble polyvinyl alcohol film layer 12, and optional second layer of water-soluble nonwoven fabric 13 may each independently contain one or more of the above-mentioned additives, such as antimicrobial agents commercially available under the trade designation MICROBAN®.

The various additives may be added to a polymer melt and extruded to incorporate the additive into a fiber or film component. Alternatively, one or more additives may be coated onto a fiber or film during or after the fabric or film forming process. Typically, when present, each of the one or more additives is present in an amount less than about 1.0 weight percent based on the total weight of the fiber, film or fabric.

B. Water-Soluble, Breathable Material Features

By combining one or more of the above-described components, the water-soluble, breathable materials of the present invention possess one or more of the following features.

1. Water-Solubility

As discussed above, the water-soluble, breathable materials of the present invention are water-soluble. Desirably, the water-soluble, breathable materials of the present invention are water-soluble in water having a water temperature of greater than about 37° C. (or greater than about 50° C., or greater than about 75° C., or greater than about 90° C.).

2. Unexpectedly High Water Vapor Transmission Rates

The water-soluble, breathable materials of the present invention also possess an unexpectedly high water vapor transmission rate (WVTR) as measured using test method ASTM E96 PROCEDURE B (2005). As noted above, the water-soluble polyvinyl alcohol film layer (e.g., water-soluble polyvinyl alcohol film layer 12) typically has a water vapor transmission rate (WVTR) of at least 1000 g/24 hr/m², but less than about 2000 g/24 hr/m² as measured using test method ASTM E96 PROCEDURE B (2005). The water-soluble, breathable materials of the present invention (e.g., water-soluble, breathable materials 10 and 20) possess a water vapor transmission rate (WVTR) of at least 1000 g/24 hr/m², and typically greater than about 2000 g/24 hr/m² as measured using test method ASTM E96 PROCEDURE B (2005).

In some embodiments of the present invention, the water-soluble, breathable material (e.g., water-soluble, breathable materials 10 and 20) has a water vapor transmission rate (WVTR) of at least about 2000 g/24 hr/m² as measured using test method ASTM E96 PROCEDURE B (2005). In other embodiments of the present invention, the water-soluble, breathable material (e.g., water-soluble, breathable materials 10 and 20) has a water vapor transmission rate (WVTR) of at least about 3000 g/24 hr/m² as measured using test method ASTM E96 PROCEDURE B (2005). In yet other embodiments of the present invention, the water-soluble, breathable material (e.g., water-soluble, breathable material 10) has a water vapor transmission rate (WVTR) of at least about 4000 g/24 hr/m² as measured using test method ASTM E96 PROCEDURE B (2005).

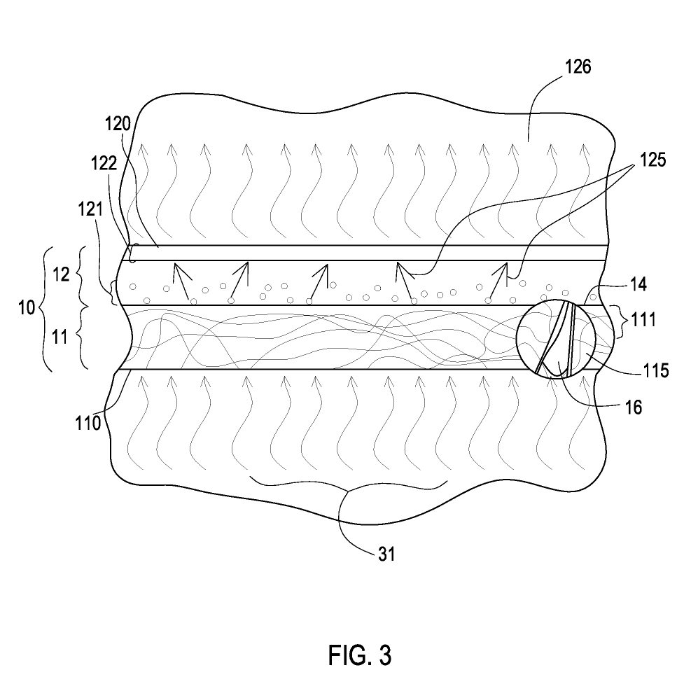

It is believed that the water-soluble, breathable materials of the present invention (e.g., water-soluble, breathable materials 10 and 20) possess an unexpectedly high water vapor transmission rate (WVTR) due to the overall material construction and one or more transport mechanisms (e.g., diffusion, absorption, desorption, convection, etc.) through the material construction as described below. As shown in FIG. 3, moisture vapor 31 (e.g., perspiration vapor) comes into contact with first major outer surface 110 of exemplary water-soluble, breathable materials 10. The first layer of water-soluble nonwoven fabric 11 closest to a wearer's skin (not shown) is composed of extremely hydrophilic polyvinyl alcohol fibers 115, thus creating a relatively large surface area. This large surface area and capillaries between the many polyvinyl alcohol fibers 115 increases the water absorbent capability of first layer of water-soluble nonwoven fabric 11.

Water beads 16 form within polyvinyl alcohol fibers 115 of first layer of water-soluble nonwoven fabric 11, and due to the wicking properties of first layer of water-soluble nonwoven fabric 11, migrate into an area 111 of first layer of water-soluble nonwoven fabric 11 adjacent to bond surface 14 and water-soluble polyvinyl alcohol film layer 12. Water enters into water-soluble polyvinyl alcohol film layer 12 along bond surface 14 and forms a high moisture concentration area 121 within water-soluble polyvinyl alcohol film layer 12 along bond surface 14. Water within high moisture concentration area 121 diffuses into a low moisture concentration area 122 rapidly toward second major outer surface 120 of water-soluble polyvinyl alcohol film layer 12 as shown by arrows 125. The moisture then evaporates from second major outer surface 120 into the air as shown by arrows 126 due to the large surface area of water-soluble polyvinyl alcohol film layer 12, which may be embossed to further increase the outer surface area of second major outer surface 120 as shown in FIG. 3. Finally, a steady state equilibrium condition is reached between all forms of moisture transport taking place, and the coupling effect between the forms of moisture transport becomes less significant.

3. Particulate Radioactive Material Transmission Rates

Although the water-soluble, breathable materials of the present invention possess an unexpectedly high water vapor transmission rate (WVTR) as measured using test method ASTM E96 PROCEDURE B (2005), the water-soluble, breathable materials of the present invention (and articles made therefrom, e.g., coveralls, scrubs, etc.) provide a barrier to particulate material such as particulate radioactive materials as measured using the test method EN 1073-2:2002, and in particular, clauses 5.1.4, 5.2 and 5.3 of test method EN 1073-2:2002.

The water-soluble, breathable materials of the present invention comply with the pre-conditioning test of clause 5.1.4 of test method EN 1073-2:2002 as described in the test method, namely, exposure of the water-soluble, breathable material to:
(a) for 4 hours to a temperature of (−30±3)° C. and allowed to return to ambient conditions; followed by—
(b) for 4 hours to an atmosphere of (60±3)° C. at 95% relative humidity, and then allowed to return to ambient conditions.

Following the pre-conditioning test of clause 5.1.4 of test method EN 1073-2:2002, the water-soluble, breathable materials of the present invention (and articles made therefrom, e.g., coveralls, scrubs, etc.) do not show any visible signs of damage or deterioration.

Protective clothing, such as coveralls and scrubs, made from the water-soluble, breathable materials of the present invention also comply with the practical performance test of clause 5.2 of test method EN 1073-2:2002 as described in the test method, namely,
4.1.2 The design of the protective clothing shall be such that the protective clothing is straightforward to put on and take off, and shall minimize the risk of contamination and shall minimize physiological stress. Testing is according to “practical performance test” under conditions as shown in Table 1 below.

TABLE 1
Practical Performance Test Conditions

| Suit Size | various |
|---|---|
| Wearers | various |
| Temperature (° C.) | 19.9 |
| Humidity (%) | 38.1 |
| Noise (dBA) | <60 |

Under this test, each wearer is fitted with an appropriately sized suit and then performs a shoveling exercise in either a kneeling position or a stooping position. Following the practical performance test of clause 5.2 of test method EN 1073-2:2002, protective clothing formed from the water-soluble, breathable materials of the present invention do not show any visible signs of damage or deterioration.

Protective clothing, such as coveralls and scrubs, made from the water-soluble, breathable materials of the present invention (as well as the water-soluble, breathable materials of the present invention themselves) further comply with the particulate radioactive material penetration requirements of a Class 1 device when tested using the Total Inward Leakage test of clause 5.3 of test method EN 1073-2:2002. Table 2 below provides classifications and maximum mean values of inward leakage of particulate radioactive material as measured at three sampling positions inside a given suit during performance of one or more activities.

TABLE 2
Total Inward Leakage Criteria

| | Mean Value of Inward Leakage | | |
|---|---|---|---|
| | at Three Sampling Positions Inside | | |
| | the Suit During Exercise of: | | Nominal |
| Class | One Activity (TIL_{E}) | All Activities (TIL_{A}) | Protection Factor |
| 3 | 0.3 | 0.2 | 500 |
| 2 | 3 | 2 | 50 |
| 1 | 30 | 20 | 5 |

Under this test, a total inward leakage method as defined in BS EN ISO 13982-1/2 is used to determine salt concentration inside a given suit as a percentage of the challenge concentration administered to the suit when the suit wearer is (1) standing, (2) walking and (3) squatting. Measurements are taken in the following areas of the suit: (1) knee area, (2) waist area, and (3) breast area.

The water-soluble, breathable materials of the present invention and protective clothing made therefrom provide a highest mean value of total inward leakage for one activity of about 12 (or about 11, or about 10, or about 9, or about 8) for the squats, and a mean of all activities of about 10 (or about 19, or about 8, or about 7, or about 6), which equates to a nominal protection factor of about 20 (or about 18, or about 16, or about 14, or about 12, or about 10, or about 8, or about 6) so as to comply with a requirements of a Class 1 device (e.g., a piece of water-soluble, breathable material of the present invention or protective clothing made therefrom).

### II. Water-Soluble, Breathable Articles

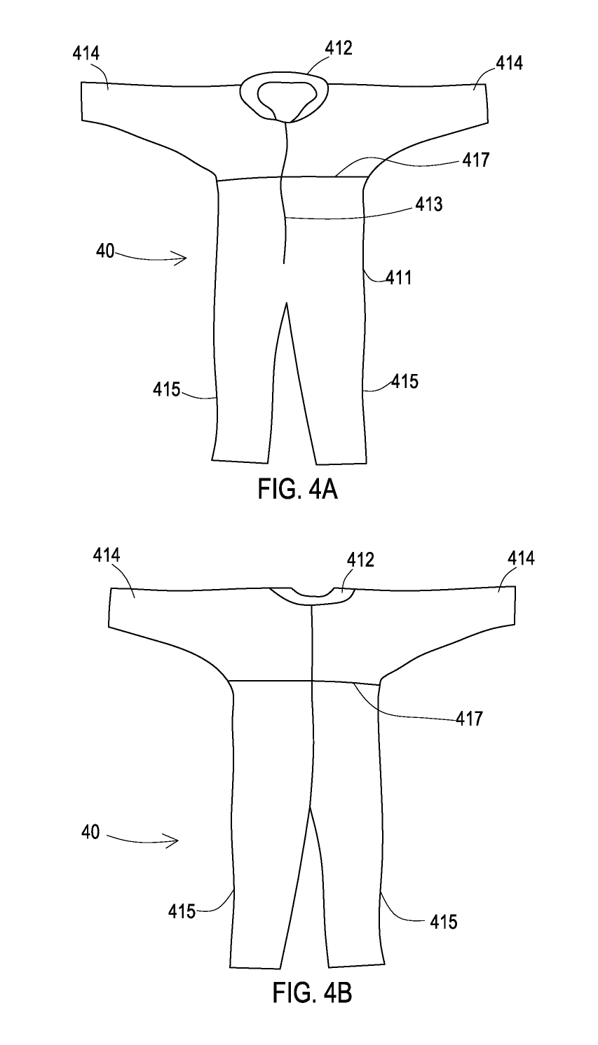

The water-soluble, breathable materials of the present invention may be used to form various water-soluble, breathable articles. Suitable articles that may be formed with the above-described water-soluble, breathable materials of the present invention include, but are not limited to, articles of clothing (e.g., coveralls, scrubs, shoe covering, booties, shirts, pants, face masks, etc.), gowns, patient drapes, and operating room equipment drapes. An exemplary article of clothing, namely, coveralls, formed from water-soluble, breathable material of the present invention in shown in FIGS. 4A-4B. As used herein, the term “coverall” refers to a garment, which covers substantially all of a human body.

As shown in FIGS. 4A and 4B, exemplary coverall 40 comprises one or more sheet materials 411 (e.g., sheets of the water-soluble, breathable material of the present invention), collar 412, closure system 413 (e.g., a zipper), sleeves 414, pant legs 415, and one or more seams 417 for connecting separate sheet materials 411 to one another. FIG. 1A depicts a frontal view of exemplary coverall 10, while FIG. 1B depicts a rear view of exemplary coverall 40. Coverall 40 covers substantially all of a wearer's body (not shown) except for the wearer's hands, feet and head. In some cases, coverall 40 may include additional components for covering a wearer's hands (e.g., gloves), feet (e.g., booties) and/or head (e.g., hood). The additional components may be integrally connected to the coverall or may be attachable to the coverall.

The water-soluble, breathable material of the present invention may also be used to form water-soluble scrubs. As used herein, the term “scrubs” refers to articles of clothing routinely used in the medical industry. The term “scrubs” includes in combination (i) a smock-like, shirt typically having a V-neck, short or long sleeves, and up to about six pockets, typically, one pocket, and (ii) a pair of pants having long or short pant legs, and up to about four pockets, typically, two pockets.

### III. Methods of Making Water-Soluble, Breathable Material and Articles Made Therefrom

The present invention is further directed to methods of making water-soluble, breathable material and water-soluble articles made therefrom. Any of the above-described individual layers used to form the various water-soluble, breathable materials (and water-soluble articles made therefrom) may be formed using conventional methods. For example, polyvinyl alcohol film layers may be forming via any film-forming process including, but not limited to, a film extrusion process, a film-forming process from solution, a film-blowing process, etc. Fiber-containing layers, such as the first nonwoven fabric layer and the optional second nonwoven fabric layer, may be formed using conventional processes including, but not limited to, meltblowing processes, spunbonding processes, spunlacing processes, hydroentangling processes, carding processes, needlepunching processes, etc.

Films and fabric layers may be joined to one another using any conventional bonding technique including, but not limited to, thermal bonding processes, adhesive bonding, mechanical bonding, etc. In one exemplary embodiment of the present invention, a polyvinyl alcohol film layer may be bonded to one or more nonwoven fabric layers using a conventional point-bonding apparatus, wherein thermal bonds are used to join the polymeric film layer to one or both of the nonwoven fabric layers. In another exemplary embodiment of the present invention, a polyvinyl alcohol film layer may be bonded to one or more nonwoven fabric layers using a high frequency (e.g., ultrasonic) point-bonding apparatus, wherein bonds are used to join the polyvinyl alcohol film layer to one or more nonwoven fabric layers. The degree of bonding, size of individual point bonds, and concentration of point bonds may vary as desired.

In one desired embodiment, the method of making water-soluble, breathable material of the present invention comprises usilizing a high frequency bonding or welding technique. In this exemplary embodiment, the method of making water-soluble, breathable material comprises feeding (i) a first layer of water-soluble nonwoven fabric comprising water-soluble polyvinyl alcohol fibers (ii) and a water-soluble polyvinyl alcohol film layer into a high frequency welding apparatus, the high frequency welding apparatus comprising a pair of nip rollers comprising (i) a first roller having a plurality of protrusions along an outer surface of the first roller, and (ii) a second roller having a substantially smooth surface, the high frequency welding apparatus providing high frequency energy across a nip area between the protrusions of the first roller and the substantially smooth surface of the second roller, and bonding the first layer of water-soluble nonwoven fabric to the water-soluble polyvinyl alcohol film layer via the high frequency energy, wherein the resulting material has a water vapor transmission rate (WVTR) of at least about 2000 g/24 hr/m² (or least about 3000 g/24 hr/m² or least about 4000 g/24 hr/m²) as measured using test method ASTM E96 PROCEDURE B (2005).

In another desired embodiment, the method of making water-soluble, breathable material of the present invention comprises feeding (i) a first layer of water-soluble nonwoven fabric comprising water-soluble polyvinyl alcohol fibers (ii) a water-soluble polyvinyl alcohol film layer, and (iii) a second layer of water-soluble nonwoven fabric comprising water-soluble polyvinyl alcohol fibers into the above-described high frequency welding apparatus, and bonding the first layer of water-soluble nonwoven fabric to the water-soluble polyvinyl alcohol film layer and the second layer of water-soluble nonwoven fabric via the high frequency energy, wherein the resulting material has a water vapor transmission rate (WVTR) of at least about 2000 g/24 hr/m² (or least about 3000 g/24 hr/m²) as measured using test method ASTM E96 PROCEDURE B (2005).

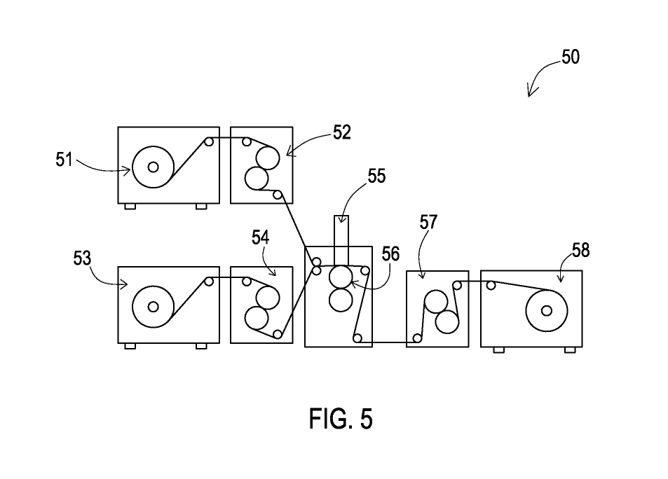

An exemplary process for forming the above-described water-soluble, breathable materials of the present invention is shown in FIG. 5. As shown in FIG. 5, exemplary process 50 comprises the following process components: PVA film unwind station 51, PVA film auto-tension control device 52, PVA non-woven fabric unwind station 53, PVA non-woven fabric auto-tension control device 54, ultrasonic welder and pressure regulator 55, roller 56, composite product automatic tension control device 57, and composite product receiving and automatically correcting device 58.

In the high frequency bonding or welding technique or ultrasonic lamination technique, a frequency ranging from about 80 to about 130 HZ may be used depending on the bond strength desired, the materials bonded, the line speed, etc. Typical line speeds may range from about 20 to about 30 meters per minute (mpm).

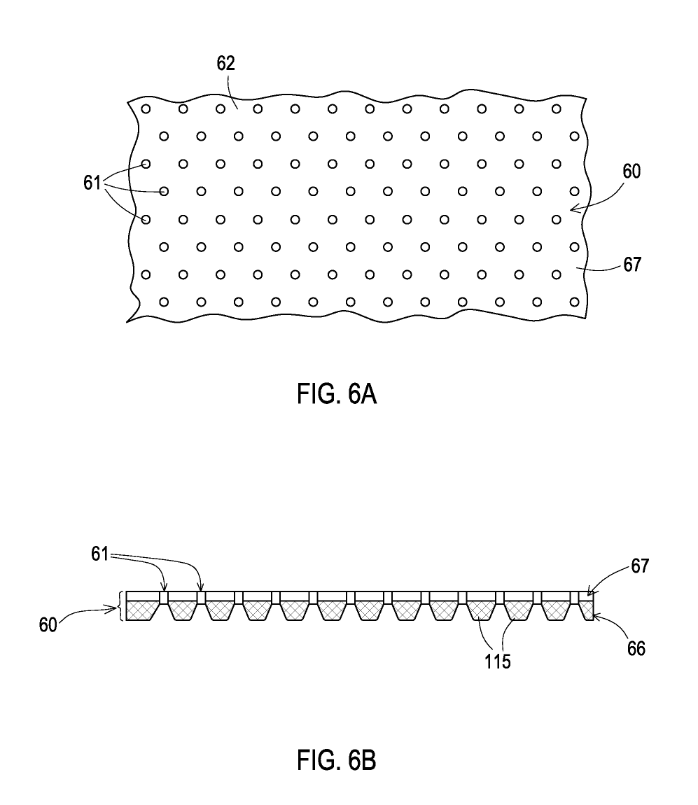

FIGS. 6A-6B depict top and side views respectively of an exemplary water-soluble, breathable material of the present invention formed via the exemplary process shown in FIG. 5. As shown in FIG. 6A, exemplary water-soluble, breathable material 60 has a plurality of point bonds 61 distributed along major outer surface 62. The density (number/unit area) of point bonds 61 along major outer surface 62 may vary depending on the degree of bonding desired. As shown in FIG. 6B, point bonds 61 result in a decrease in an overall thickness of exemplary water-soluble, breathable material 60 (comprising a first layer of water-soluble nonwoven fabric 66 comprising water-soluble polyvinyl alcohol fibers 115 point-bonded to a water-soluble polyvinyl alcohol film layer 67) at the point bond locations.

A variety of high frequency bonding or welding apparatus may be used in the present invention. Suitable types of high frequency bonding or welding equipment are available from companies such as Chase Machine & Engineering, Inc. (West Warwick, R.I.).

Other bonding methods may be used although high frequency bonding or welding is a desired bonding method. Other suitable bonding methods include, but are not limited to, heat/thermal bonding with or without pressure, and adhesive bonding using a glue-like material.

### IV. Methods of Using Water-Soluble Articles

The present invention is further directed to methods of using the above-described water-soluble, breathable materials and articles made therefrom. In one exemplary embodiment, the method comprises a method of providing a barrier between a person and radioactive material generated in the nuclear industry. In this exemplary embodiment, the method comprises forming an article of clothing (e.g., coveralls, scrubs, gloves, glove liners, etc.) from one of the above-described water-soluble, breathable materials, and utilizing the article of clothing as protective clothing in the nuclear industry.

In another exemplary embodiment, the method comprises a method of providing a barrier between a patient and a piece of equipment in an operating room setting, wherein the method comprises the step of positioning an equipment drape formed from one of the above-described water-soluble, breathable materials over at least a portion of the piece of equipment to separate the patient from at least a portion of the piece of equipment. Typically, the equipment drape is used to cover the entire piece of equipment. In one desired embodiment, the piece of equipment comprises an operating room table and/or operating room table mattress.

In another exemplary embodiment, the method comprises a method of covering a patient during a surgical procedure so as to provide a barrier between the patient and, for example, a surgeon and/or to expose a surgical site on a patient while covering at least a portion of the remaining body of a patient (e.g., through a fenestration in the patient drape).

Following use, the above-described water-soluble, breathable materials (and articles made therefrom) may be disposed of by solubilizing the water-soluble article by exposing the water-soluble article to a water temperature in which the water-soluble article become soluble (e.g., greater than about 37° C., or greater than about 50° C., or greater than about 75° C., or greater than about 90° C.).

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### Example 1

### Preparation of a Polyvinyl Alcohol Film

An aqueous solution comprising about 15 wt % polyvinyl alcohol (PVOH pellets commercially available from Fujian Textile and Fiber Group (Fujian, China) under the Product Code 2499) and 85 wt % water was prepared. The aqueous solution was blended for about 1.5 hours at a blend temperature of about 85 to 95° C. The blended mixture was then deposited on a moving flat surface having a surface width of about 1 meter (m) so as to form a coating having an average coating thickness of about 30 μm. The moving flat surface covered with aqueous solution was moved through a circulating oven having an oven temperature of about 98° C. A given square meter of aqueous solution was subjected to the oven temperature of about 98° C. for about 12 minutes so as to remove water from the aqueous solution and result in a polyvinyl alcohol film. The resulting polyvinyl alcohol film exited the oven and was separated from the moving surface and taken-up in roll form with minimal tension on the film (i.e., no stretching).

The resulting unstretched polyvinyl alcohol film comprised 100 wt % polyvinyl alcohol and had a film thickness of about 15 microns (μm). The resulting unstretched polyvinyl alcohol film had a water vapor transmission rate (WVTR) of about 1168 g/24 hr/m² as measured using test method ASTM E96 PROCEDURE B (2005).

### Example 2

### Preparation of a Nonwoven PVA Material

A nonwoven fabric comprising water-soluble polyvinyl alcohol fibers was formed using a conventional spunlacing process. The resulting nonwoven polyvinyl alcohol fabric comprised 100 wt % polyvinyl alcohol and had a basis weight of about 45 grams per square meter (gsm).

### Example 3

### Preparation of a Water-Soluble, Breathable Bi-Laminate Material

The unstretched polyvinyl alcohol film formed in Example 1 and the water-soluble PVA nonwoven fabric formed in Example 2 were each independently fed into a high frequency bonding apparatus. The high frequency bonding apparatus comprised (i) a first roller having a width of about 1.6 meters and thousands of cylindrical shaped protrusions along an outer surface of the first roller, and (ii) a second roller having a width of about 1.6 meters and a substantially smooth surface. Each of the cylindrical shaped protrusions provided high frequency energy at a frequency of about 120 Hz at points of contact between the first roller and the second roller so as to supply high frequency energy to the material passing between the rollers. Both rollers had a roll diameter of about 45.7 centimeters (cm) (18 inches).

The unstretched polyvinyl alcohol film and the nonwoven web of cross-lapped spun-laced polyvinyl alcohol fibers were fed through the high frequency bonding apparatus at a line speed of about 25 meters per minute (mpm). Each protrusion provided a high frequency bonding area having an average bond area of about 0.64 mm² with about 16 bond areas per cm².

The resulting bi-laminate composite material had a water vapor transmission rate (WVTR) of about 4139 g/24 hr/m² as measured using test method ASTM E96 PROCEDURE B (2005), and was hot water soluble. The resulting bi-laminate composite material also dissolved in hot water having a water temperature of 90° C. within 10 minutes.

The resulting bi-laminate composite material was formed into coveralls having a configuration as shown in FIGS. 4A-4B, and then tested for particulate radioactive material barrier properties as measured using the test method EN 1073-2:2002, and in particular, clauses 5.1.4, 5.2 and 5.3 of test method EN 1073-2:2002.

The water-soluble, breathable coveralls complied with the pre-conditioning test of clause 5.1.4 of test method EN 1073-2:2002 as described in the test method. Following the pre-conditioning test, the water-soluble, breathable coveralls did not show any visible signs of damage or deterioration.

The water-soluble, breathable coveralls also complied with the practical performance test of clause 5.2 of test method EN 1073-2:2002. Following the practical performance test of clause 5.2 of test method EN 1073-2:2002, the water-soluble, breathable coveralls did not show any visible signs of damage or deterioration.

The water-soluble, breathable coveralls further complied with the particulate radioactive material penetration requirements of a Class 1 device when tested using the Total Inward Leakage test of clause 5.3 of test method EN 1073-2:2002. The water-soluble, breathable coveralls provided a highest mean value of total inward leakage for one activity of about 12 for the squats, and a mean of all activities of about 10, which equated to a nominal protection factor of about 20.

### Example 4

### Preparation of a Breathable, Water-Soluble Tri-Laminate Material

The procedure of Example 3 was repeated except the unstretched polyvinyl alcohol film formed in Example 1 was fed into the high frequency bonding apparatus along with two outer layers of the water-soluble PVA nonwoven fabric formed in Example 2.

The resulting tri-laminate composite material had a water vapor transmission rate (WVTR) of about 3118 g/24 hr/m² as measured using test method ASTM E96 PROCEDURE B (2005). The resulting tri-laminate composite material also dissolved in hot water having a water temperature of 90° C. within 10 minutes.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

1. A water-soluble, multi-layer material comprising:
a first layer of water-soluble nonwoven fabric extending along a first surface of the material, said first layer of water-soluble nonwoven fabric comprising water-soluble polyvinyl alcohol fibers; and
a water-soluble polyvinyl alcohol film layer bonded to said first layer of water-soluble nonwoven fabric, said water-soluble polyvinyl alcohol film layer being substantially free of any particulate material;
wherein said material has a water vapor transmission rate (WVTR) of at least about 2000 g/24 hr/m² as measured using test method ASTM E96 PROCEDURE B (2005).

2. The material of claim 1, wherein said material has a water vapor transmission rate (WVTR) of at least about 3000 g/24 hr/m² as measured using test method ASTM E96 PROCEDURE B (2005).

3. The material of claim 2, wherein said material has a water vapor transmission rate (WVTR) of at least about 4000 g/24 hr/m² as measured using test method ASTM E96 PROCEDURE B (2005).

4. The material of claim 3, wherein said first layer comprises a cross-lapped, spunlaced nonwoven fabric.

5. The material of claim 4, wherein said water-soluble polyvinyl alcohol film layer consists essentially of polyvinyl alcohol.

6. The material of claim 5, wherein said material is soluble in water having a water temperature of greater than 50° C.

7. The material of claim 6, wherein said material is soluble in water having a water temperature of greater than 75° C.

8. The material of claim 7, wherein said material is soluble in water having a water temperature of greater than 90° C.

9. The material of claim 1, wherein the first layer of water-soluble nonwoven fabric and the water-soluble polyvinyl alcohol film layer are bonded to one another using a high frequency welding technique without additional bonding agents.

10. The material of claim 9, wherein said material consists essentially of said first layer of water-soluble nonwoven fabric and said water-soluble polyvinyl alcohol film layer.

11. The material of claim 1, wherein said first layer of water-soluble nonwoven fabric forms a first exposed major surface of said material, and said water-soluble polyvinyl alcohol film layer forms a second exposed major surface of said material opposite said first exposed major surface.

12. The material of claim 1, wherein said material further comprises:
a second layer of water-soluble nonwoven fabric extending along a second surface of the material and bonded to said water-soluble polyvinyl alcohol film layer opposite said first layer of water-soluble nonwoven fabric, said second layer of water-soluble nonwoven fabric comprising water-soluble polyvinyl alcohol fibers.

13. The material of claim 1, wherein said material meets particulate radioactive material barrier property requirements of a Class 1 device as measured using test method EN 1073-2:2002 when formed into protective clothing.

14. An article of clothing comprising the material of claim 13.

15. The article of clothing of claim 14, wherein said article of clothing comprises a coverall.

16. An article of clothing comprising:
a first layer of water-soluble nonwoven fabric extending along and forming a first exposed major surface of the article, said first layer of water-soluble nonwoven fabric comprising water-soluble polyvinyl alcohol fibers; and
a water-soluble polyvinyl alcohol film layer bonded to said first layer of water-soluble nonwoven fabric and forming a second exposed major surface of the article opposite said first exposed major surface, said water-soluble polyvinyl alcohol film layer being substantially free of any particulate material;
wherein said article has a water vapor transmission rate (WVTR) of at least about 2000 g/24 hr/m² as measured using test method ASTM E96 PROCEDURE B (2005).

17. The article of clothing of claim 16, wherein said water-soluble polyvinyl alcohol film layer consists essentially of polyvinyl alcohol.

18. The article of clothing of claim 17, wherein the first layer of water-soluble nonwoven fabric consists essentially of cross-lapped, spun-laced nonwoven fabric consisting essentially of polyvinyl alcohol fibers.

19. The article of clothing of claim 18, wherein said first layer of water-soluble nonwoven fabric has a basis weight of from about 30 to about 60 gsm, and said water-soluble polyvinyl alcohol film layer has a film thickness of from about 10 μm to about 30 μm.

20. The article of clothing of claim 19, wherein said article of clothing comprises a coverall.

21. The article of clothing of claim 19, wherein said article of clothing comprises scrubs.

22. The article of clothing of claim 16, wherein said article of clothing meets particulate radioactive material barrier property requirements of a Class 1 device as measured using test method EN 1073-2:2002.

23. A method of making the material of claim 1, said method comprising:
feeding the first layer of water-soluble nonwoven fabric and the water-soluble polyvinyl alcohol film layer into a high frequency welding apparatus, the high frequency welding apparatus comprising a pair of nip rollers comprising (i) a first roller having a plurality of protrusions along an outer surface of the first roller, and (ii) a second roller having a substantially smooth surface, the high frequency welding apparatus providing high frequency energy across a nip area between the protrusions of the first roller and the substantially smooth surface of the second roller; and
bonding the first layer of water-soluble nonwoven fabric to the water-soluble polyvinyl alcohol film layer via the high frequency energy.
